(19) United States
(12) Patent Application Publication
(10) Pub. No.: US 2020/0223524 A1
(43) Pub. Date: Jul. 16, 2020

(54) AIRCRAFT COMPRISING AN IMPROVED FUSELAGE

(71) Applicant: MECAER AVIATION GROUP S.P.A., Borgomanero (NO) (IT)

(72) Inventor: Vincenzo MASSARELLI, Borgomanero (NO) (IT)

(21) Appl. No.: 16/647,206

(22) PCT Filed: Sep. 14, 2018
(86) PCT No.: PCT/IB2018/057074

§ 371 Date: Mar. 13, 2020

(30) Foreign Application Priority Data
Sep. 15, 2017 (IT) 102017000103537

(51) Int. Cl. B64C 1/06; B64C 1/10

(52) U.S. Cl. CPC B64C 1/068; B64C 2001/009; B64C 1/066; B64C 1/10

(57) ABSTRACT

Aircraft comprising a fuselage, which in turn comprises an outer wall insulating from the outside an inner volume of the aircraft and an inner wall with respect to the outer wall defining a first volume pressurized at a first pressure level, the inner wall and the outer wall being separated from each other by a second volume and being connected by connection means housed in the second volume, this latter being pressurized to a second pressure level, which is at least one order of magnitude lower than the first level.

### CROSS-REFERENCE TO RELATED APPLICATIONS

This application claims priority from Italian Patent Application No. 102017000103537 filed on 15 Sep. 2017, the disclosure of which is incorporated by reference.

### TECHNICAL FIELD

The present invention relates to an aircraft, in particular to the fuselage of an aircraft.

### BACKGROUND ART

The aircraft usually comprise a fuselage comprising essentially an outer wall, which separates the interior of the aircraft from the outside, and an inner wall defining a useful space for carrying passengers and/or objects.

The outer wall is normally exposed to more sources of noise, such as e.g. the noise caused by the aircraft engine or the noise due to the aerodynamic fluctuations of the air during the flight.

This noise is generally transmitted from the outer wall to the inner wall, to which it is connected, thus transferring the noisy vibrations inside the aircraft and creating disturbances to the passengers and/or to the objects within the useful space.

To solve this problem it is known the use of damping means arranged between the inner and outer walls, which are designed to reduce the transmission of the aforesaid noise acting on the outer wall of the fuselage to the inner wall and therefore to the useful space.

Examples of known damping means are soundproofing panels or barriers housed in the space between the outer and the inner wall of the fuselage. Such means damp the vibrations between the outer wall and the inner wall. However, a part of the noise caused by the vibrations acting on the outer wall of the fuselage is in any case transmitted to the inner wall and therefore within the useful space.

Moreover, the aforesaid damping means increase the weight of the aircraft, thus increasing its fuel consumption.

Examples of aircraft fuselages are shown in EP2465768 A2, DE102007008987 A1, US587079 A, US2012325344 A1, DE1020132237042 B3 or US2009/179110 A1.

There is therefore a need to improve aircraft fuselages in order to further damp the transmission of vibrations within the aforementioned useful space, without, however, increasing the non-paying aircraft load.

### DISCLOSURE OF INVENTION

The object of the present invention is to provide an aircraft comprising a fuselage, which allows solving at least one of the aforesaid problems in a simple and inexpensive way.

Said object is achieved by an aircraft according to claim 1.

### BRIEF DESCRIPTION OF THE DRAWINGS

For a better understanding of the present invention, a preferred embodiment is described below by way of non-limiting example and with reference to the attached drawings, in which:

FIG. 1 schematically shows a cross-section of an aircraft according to the invention;

FIG. 2 shows a schematic side view, with parts removed for clarity's sake, of the aircraft of FIG. 1;

FIG. 3 is a partially sectioned axonometric view of the aircraft of FIG. 1; and

FIGS. 4 and 5 are schematic representations, with parts removed for clarity's sake, of a bleed air system of an aircraft according to the invention.

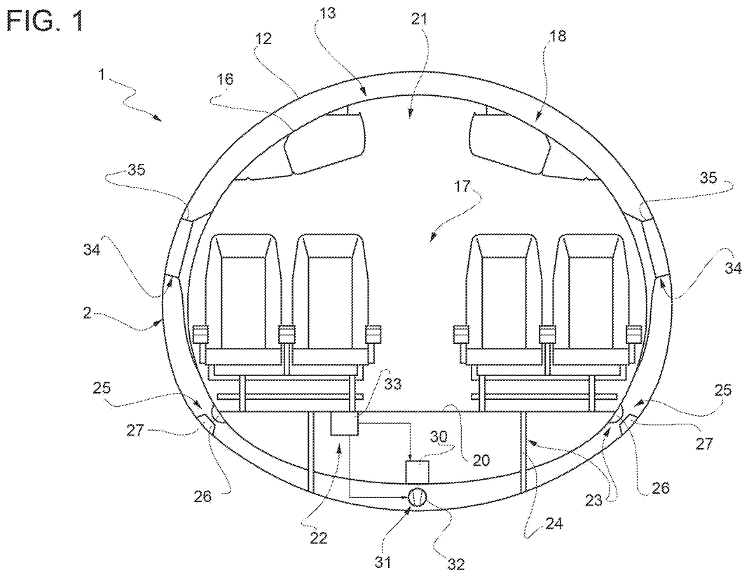

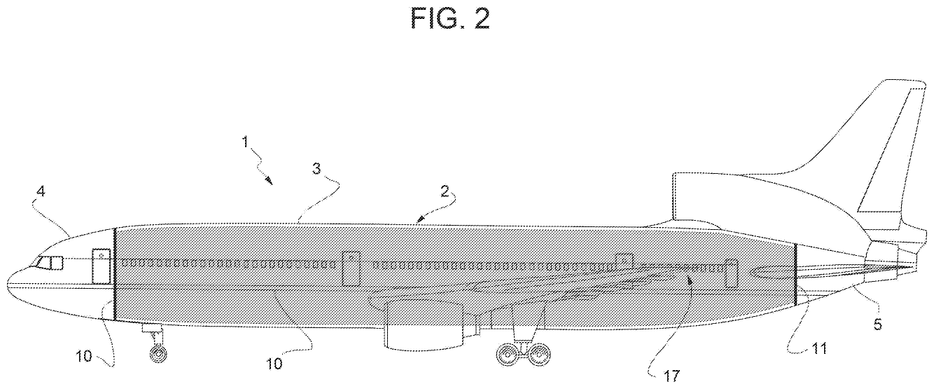

### BEST MODE FOR CARRYING OUT THE INVENTION

The present invention will now be described with reference to an aircraft for the transport of persons. It is however clear that this invention can be applied to any other type of aircraft.

In the attached figures, the reference number 1 indicates an aircraft of a known type, in particular an aircraft for the transport of persons.

The aircraft 1 essentially comprises a fuselage 2 defining a substantially central main portion 3 of the aircraft 1, a front drive portion 4 (also known as the cockpit) and a rear portion 5, also known as the tail.

The fuselage 2 substantially extends from the front portion 4, from which it is separated by a front wall 10, to the rear portion 5, from which it is separated by a rear wall 11.

As known, the fuselage 2 essentially comprises an outer wall 12 configured to isolate from the outside an inner volume 13 of the aircraft. The inner volume 13 is therefore laterally delimited by the outer wall 12 and axially delimited by the pair of front and rear walls 10, 11.

The fuselage 2 further comprises an inner wall 16, housed inside the volume 13 and defining a useful volume 17, configured to house people and/or objects based on the use of the aircraft 1. The useful volume 17 is closed, laterally delimited by the inner wall 16 and axially delimited by the pair of front and rear walls 10, 11.

Preferably, the inner wall 16 has a substantially cylindrical shape and has an outer diameter radially smaller than the inner diameter of the outer wall 12. Between the outer wall 12 and the inner wall 16, the fuselage 2 therefore comprises an intermediate volume 18, laterally defined by the outer and inner walls 12 and 16 and axially defined by the front and rear walls 10 and 11.

Advantageously, the front and rear walls 10, 11 are provided with gaskets of the known type and not shown, configured to tight seal the useful volume 17 and the intermediate volume 18.

Preferably, the outer wall 12 and the inner wall 16 may be made of composite panels, more preferably of panels made of carbon fibre composite material.

The aircraft 1 can further comprise a floor 20, housed inside the useful volume 17, connected to the inner wall 16 and preferably arranged below the central line of the volume 17.

The floor 20 therefore divides the useful volume 17 into an upper volume portion 21 and a lower volume portion 22. Advantageously, the upper volume portion 21 is suitable for transporting objects and/or persons and is therefore provided with elements suitable for this purpose, such as seats or storage compartments.

The lower volume portion 22 is suitable for housing connection means 23 between the floor 20, the inner wall 16 and the outer wall 12.

Said connection means 23 can comprise first elements 24 configured to transfer to the outer wall 12 the load weighing on the floor 20 and therefore on the inner wall 16.

Preferably, said first elements 24 comprise a plurality of uprights connecting, for example by means of bolts, the floor 20 to the outer wall 12 and/or to the inner wall 16.

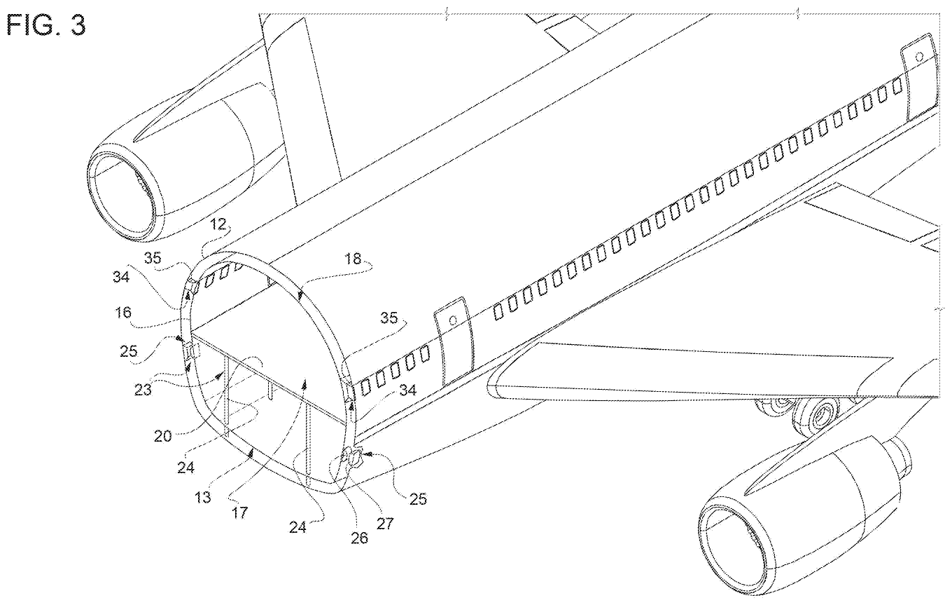

As shown in FIG. 3, the connection means 23 can comprise second elements 25 configured to limit longitudinal relative displacements between the outer wall 12 and the inner wall 16.

Preferably, the second elements 25 comprise a plurality of protrusions 26 extending from the inner wall 16 to the outer wall 12 within the intermediate volume 18 and configured to cooperate with respective stopping means 27 carried by the outer wall 12.

Preferably, these protrusions are arranged at the height of the floor 20, and even more preferably, they are arranged in a row.

Advantageously, the air inside the useful volume 17 is pressurized to a first pressure level and/or conditioned. This first pressure level is based on what is carried in the aforesaid useful volume 17. The aforesaid first pressure level is comprised between 0.6 bar and 1 bar, preferably between 0.7 and 0.9 bar and even more preferably is about 0.8 bar.

The aforesaid first pressure level is obtained by a pressurization/conditioning circuit 30, preferably acting inside the useful volume 17, even more preferably below the floor 20 in the lower volume 22.

Advantageously, the intermediate volume 18 is pressurized to a second pressure level, this second pressure level being at least one order of magnitude lower than the first pressure level, preferably less than 100 mmHg (0.13 bar). In particular, with respect to the above-mentioned values of the first pressure level, this second pressure level is between 0.06 bar and 0.1 bar, preferably between 0.07 and 0.09 bar and even more preferably is about 0.08 bar.

The aforesaid second pressure level is obtained by depressurization means 31 configured to lower and subsequently maintain the pressure of the intermediate volume 18. Advantageously, such depressurization means 31 can be integrated with a bleed air system 40 of the aircraft, as described hereinafter.

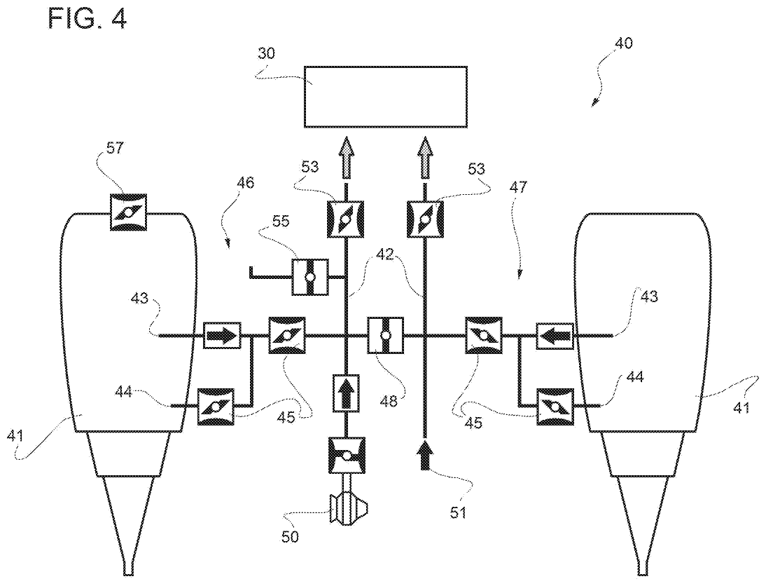

Aircrafts usually comprise a bleed air system 40, schematically shown in FIG. 4, configured to bleed part of the compressed air used by the aircraft engines 41 for using it in the air conditioning/pressurisation system 30.

Preferably, such compressed air is bled, for each engine 41, by at least two different stages, a low pressure stage 43 and a high pressure stage 44, fluidly connected to the conditioning/pressurisation system 30 by means of a pipe 42.

The adjustment of the flows from the stages 43, 44 to the system 30 is carried out by a pair of regulation valves 45, arranged downstream of the stages 43, 44 on the pipe 42.

The flows bled from the two engines 41 are separated in two subsystems 46, 47, which can be interconnected by means of an isolation valve 48.

Advantageously, the bleed system 40 further comprises an air intake 50 and an auxiliary power unit 51. Preferably, the air intake 50 and the auxiliary power unit 51 are respectively fluidly connected the one to the subsystem 46, downstream of the relative valve 45, and the other to the subsystem 47, again downstream of the relative valve 45.

The bleed system 40 further comprises respective valves 53, arranged upstream with respect to the conditioning/pressurisation circuit 30, but downstream with respect to the elements 50 and 51 and configured to regulate the bled flow towards the system.

According to the present invention, in order to bring the volume 18 to the second pressure level, at least one of the subsystems 46, 47 comprises an additional valve 55 configured to selectively connect the bleed system 40 to the intermediate volume 18 and a valve 57 formed by modifying the nacelle of one of the engines 41 and configured to completely or partially close the air inlet thereof with respect to the environment.

The depressurization means 31 can further comprise a vacuum pump 32 housed inside the intermediate volume 18 and configured to maintain the second pressure level generated by the bleed system 40.

Advantageously, the aircraft 1 may comprise a control unit 33 configured to regulate the operation of the pressurization/conditioning circuit 30 of the useful volume 17 and/or the depressurization means 31 of the intermediate volume 18.

The fuselage 2 further comprises a plurality of support means 34 configured to withstand the pressure loads caused by the depressurization of the intermediate volume 18 on some elements of the aircraft 1, such as for example windows and/or doors.

Preferably, these support elements comprise spacer rings 35 arranged in the intermediate volume 18 between the outer wall 12 and the inner wall 16, longitudinally along the aircraft 1 and preferably in succession. For example, these spacer rings 35 are configured to completely surround the perimeter of a door 1 or a window of the aircraft to keep the intermediate volume 18 insulated and prevent the pressure load due to the low pressure condition generated therein from weighing on said door or window.

The operation of the aircraft 1 according to the present invention is as follows.

As mentioned, during the operation of the aircraft 1 there are two sources of noise, the one due to the aircraft propulsion system and the other due to the vibrations caused by the aerodynamic stresses, both acting on the outer wall 12.

Thanks to the fact that the pressure in the intermediate volume 18 is much lower than the one in the volume 17, the vibrations acting on the outer wall 12 are damped due to the rarefaction of the air in the aforementioned intermediate volume 18 and therefore are not transmitted, namely are significantly less transmitted to the inner wall 16.

Since the connection means 23 constrain the inner wall 16 to the outer wall 12, a residual part of the aforementioned vibrations is in any case transmitted, for example through the connections between the floor 20 and the outer wall 12, or through the aforementioned first elements 24, as however already happens in aircrafts equipped with soundproofing panels.

The afore described damping can be carried out continuously during the operation of the aircraft 1 while maintaining constantly operating depressurization means 31 and therefore maintaining a constant second pressure level during the entire operation of the aircraft 1.

Alternatively, the aforesaid operation can be variably activated depending on the achievement of an operating threshold of the aircraft 1. This operating threshold may be a predetermined altitude of the aircraft 1, preferably the cruising one.

As previously mentioned, the bleed system 40 is configured, during the departure of the aircraft 1 or upon reaching the aforementioned operating threshold, to generate the second pressure level inside the volume 18.

In a first operating condition of the bleed system 40, (FIG. 4), part of the air compressed by the engines 41 is conveyed towards the pressurization/conditioning circuit 30, and in this case the valves 45, 53 and 57 are open and the valve 55 is closed.

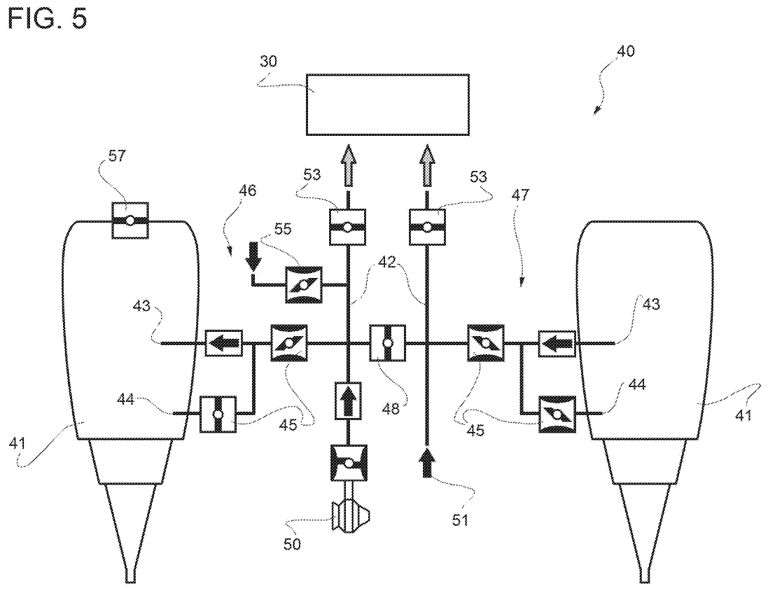

In a second operating condition of the bleed system 40, shown in FIG. 5, the valve 45 of the stage 44 is closed, just like the valves 53 and the valve 57, while the valve 55 and the valve 45 of the stage 43 are open. In this configuration, when the engine 41 associated with the subsystem 46 starts, it must draw air from the pipe 42 to operate, and can only draw it from the inner volume 18, which is the only air source fluidly connected to the stage 43 due to the closure of the valve 57.

Once reached the second pressure level, the control unit 33 re-establishes the positioning of the valves 45, 53 and 55 and the engine can return to the previously described operation. This second pressure level is maintained by the vacuum pump 32.

The achievement of the second pressure level 18 can be monitored, for example, by means of a pressure sensor, not shown, arranged inside the volume 18 and electronically connected to the control unit 33.

During the operation of the aircraft 1, the connection means 23 transfer to the inner wall 16, through the first elements 24, the vertical loads that are exerted on the outer wall 12. The connection means 23 also prevent any relative vertical displacement between the outer wall 12 and the inner wall 16 through the same first elements 24.

Moreover, the connection means 23 can transfer to the inner wall 16 the longitudinal loads that are exerted on the outer wall 12 by the second elements 25. At the same time, the second elements 25 allow limiting any relative longitudinal displacement between the outer wall 12 and the inner wall 16.

With reference to the foregoing, the advantages of an aircraft provided with an improved fuselage according to the invention are evident.

Thanks to the second pressure level in the volume 18, which is at least one order of magnitude lower than the first pressure level in the useful volume 17, it is possible to effectively damp the vibrations transmitted by the outer wall 12 and thus considerably reduce the noise produced by such vibrations within the useful volume 17.

Moreover, thanks to the absence of soundproofing panels, despite the presence of the depressurization means 31, the weight of the aircraft 1 is reduced, or at least is about the same with respect to solutions using soundproofing panels.

Furthermore, if the depressurization means 31 are selectively activated, for example at the cruising altitude of the aircraft 1, the aircraft 1 can consume less fuel.

Furthermore, the second pressure level helps improve the thermal insulation between the outer wall 12 towards the inner wall 16, and therefore towards the inside of the useful volume 17. This thermal insulation of the useful volume 17 helps increase the energy efficiency of the air conditioning/pressurisation circuit 30.

Moreover, since the depressurization means 31 can be automatically or manually controlled by means of the control unit 33, such vibration damping can be activated at will, for example in situations of particular need.

Finally, the fact that the depressurization means 31 are integrated with the aircraft's bleed system 41 allows generating the second pressure level in an easy and inexpensive way.

Finally, it is clear that an aircraft 1 made according to the present invention can be subjected to modifications and variations, which however do not depart from the scope of protection defined by the appended claims.

For example, the inner wall 16 could be connected to the outer wall 12 differently from what shown.

Furthermore, the depressurization means 31 could be absent and this second level of constant pressure could be obtained at each stop of the aircraft 1.

Finally, other parts of the aircraft 1, such as for example the cockpit, could comprise a fuselage according to the present invention.

1-11. (canceled)

1. An aircraft comprising a fuselage, in turn comprising an outer wall, configured to isolate an inner volume of said aircraft from the outside, an inner wall with respect to said outer wall and a pair of front and rear walls, said inner wall and said pair of walls defining a first volume closed and isolated in said inner volume, said first volume being pressurized to a first pressure level based on the use of this latter, said inner wall and said outer wall defining between them and said pair of front and rear walls a second volume and being connected to one another by connection means configured to transfer the load weighing on said inner wall to said outer wall, said aircraft being characterized in that said second volume is pressurized to a second pressure level, which is at least one order of magnitude lower than said first level.

2. The aircraft according to claim 1, characterized in that said second pressure level is less than 0.1 bar.

3. The aircraft according to claim 1, characterized in that said second pressure level is approximately 0.1 bar.

4. The aircraft according to claim 1, characterized in that it comprises depressurization means configured to generate said second pressure level in said second volume.

5. The aircraft according to claim 1, characterized in that said second pressure level remains constant during the operation of said aircraft.

6. The aircraft according to claim 1, characterized in that said second pressure level is variable based on the operating condition of said aircraft.

7. The aircraft according to claim 6, characterized in that said second pressure level is variable based on the altitude quota of said aircraft.

8. The aircraft according to claim 4, characterized in that said depressurization means are integrated with a bleed system for said aircraft.

9. The aircraft according to claim 1, characterized in that said connection means comprise first support elements configured to support the vertical stresses between said inner wall and said outer wall.

10. The aircraft according to claim 1, characterized in that said connection means comprise second support elements configured to limit the relative longitudinal displacements between said inner wall and said outer wall.

11. The aircraft according to claim 10, characterized in that said second elements comprise protrusions fixed to the one of either said outer wall or said inner wall and configured to cooperate with equivalent stopping means carried by the other of either said inner or said outer wall.
